(19) United States
(12) Patent Application Publication
(10) Pub. No.: US 2025/0377622 A1
(43) Pub. Date: Dec. 11, 2025

(54) IMAGE FORMING APPARATUS

(71) Applicant: CANON KABUSHIKI KAISHA, Tokyo (JP)

(72) Inventor: RIKI MIYAKAWA, Chiba (JP)

(21) Appl. No.: 19/227,364

(22) Filed: Jun. 3, 2025

(30) Foreign Application Priority Data
Jun. 11, 2024 (JP) 2024-094314

(51) Int. Cl. G03G 15/00; G03G 15/20; G03G 21/20

(52) U.S. Cl. CPC G03G 15/602; G03G 15/2039; G03G 15/5004; G03G 15/5025; G03G 15/607; G03G 21/203; G03G 21/206; G03G 2215/00772; G03G 2215/00776

(57) ABSTRACT

An image forming apparatus includes an apparatus main body including an image forming unit for forming an image on a recording material and an environment sensor for acquiring environment information including at least one of a temperature and a humidity, the apparatus main body being configured to set an image forming condition on the basis of the environment information acquired by the environment sensor; and an image reading apparatus including a conveying roller for conveying an original, a motor for driving the conveying roller, a reading sensor for reading image information from the original conveyed by the conveying roller, and a controller for controlling the motor, the image reading apparatus being provided on the apparatus main body. The controller controls a driving speed of the conveying roller by the motor on the basis of the environment information acquired by the environment sensor of the apparatus main body.

### BACKGROUND

### Field of the Technology

The present disclosure relates to an image forming apparatus for forming an image on a recording material.

### Description of the Related Art

In Japanese Laid-Open Patent Application (JP-A) No. Hei4-236565, an original reading apparatus which is provided in the neighborhood of a feeding (conveying) roller for feeding (conveying) an original and which is for correcting a driving frequency of a pulse motor for driving the feeding roller is disclosed. In JP-A No. 2005-269601, an original conveyance reading apparatus in which a rotational speed of a stepping motor for driving a sheet discharging roller, on the basis of a detection result of a contact temperature detecting sensor contacting an outer peripheral surface of a sheet discharging roller for discharging an original is disclosed. In SP-A No. 2006-270822, an image reading apparatus in which a reading (cycle) period of a CCD is corrected on the basis of an environment condition acquired by a temperature sensor and a humidity sensor which are provided in the neighborhood of a conveying roller for conveying an original is disclosed.

In constitution of the above-described reading apparatuses, for performing control of the motor driving speed or the reading period depending on the environment condition, there is a need to dispose the sensor(s) in the neighborhood of the feeding (conveying) roller in an original feeding (conveying) device, and thus leads to an increase in number of component parts due to addition of the sensor(s) and an increasing in cost.

### SUMMARY

The present disclosure is directed to provide an image forming apparatus capable of improving reading accuracy of an image with a simple constitution.

According to an aspect of the present disclosure, there is provided an image forming apparatus comprising: an apparatus main body including an image forming unit for forming an image on a recording material and an environment sensor for acquiring environment information including at least one of a temperature and a humidity, the apparatus main body being configured to set an image forming condition on the basis of the environment information acquired by the environment sensor; and an image reading apparatus including a conveying roller for conveying an original, a motor for driving the conveying roller, a reading sensor for reading image information from the original conveyed by the conveying roller, and a controller for controlling the motor, the image reading apparatus being provided on the apparatus main body, wherein the controller controls a driving speed of the conveying roller driven by the motor, on the basis of the environment information acquired by the environment sensor of the apparatus main body.

According to another aspect of the present disclosure, there is provided an image forming apparatus comprising: an apparatus main body including an image forming unit for forming an image on a recording material and an environment sensor for acquiring environment information including at least one of a temperature and a humidity, the apparatus main body being configured to set an image forming condition on the basis of the environment information acquired by the environment sensor; and an image reading apparatus including a conveying roller for conveying an original, a reading sensor for reading image information line by line from the original conveyed by the conveying roller, and a controller for controlling the reading sensor, the image reading apparatus being provided on the apparatus main body, wherein the controller controls a reading period when the reading sensor reads the image information, on the basis of the environment information acquired by the environment sensor of the apparatus main body.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic view of an image forming apparatus according to a first embodiment.

FIG. 2 is a perspective view of an image reading apparatus in the first embodiment.

FIG. 3 is a schematic view of the image reading apparatus in the first embodiment.

FIG. 4 is an illustration of the image reading apparatus in the first embodiment.

FIG. 5 is a block diagram showing a control system of the image forming apparatus according to the first embodiment.

FIG. 6 is a flowchart showing a control method of the image reading apparatus in the first embodiment.

Parts (a) and (b) of FIG. 7 are correction tables of a motor driving speed in the first embodiment.

Parts (a), (b), and (c) of FIG. 8 are flowcharts each showing a control method of an image reading apparatus in a modified embodiment.

Parts (a) and (b) of FIG. 9 are flowcharts each showing a control method of an image reading apparatus in another modified embodiment.

FIG. 10 is a flowchart showing a control method of an image reading apparatus in a second embodiment.

FIG. 11 is a flowchart showing a control method of an image reading apparatus in a third embodiment.

Parts (a) and (b) of FIG. 12 are flowcharts each showing a control method of an image reading apparatus in a modified embodiment.

FIG. 13 is a correction table of a motor driving speed in the third embodiment.

FIG. 14 is a flowchart showing a control method of an image reading apparatus in a fourth embodiment.

FIG. 15 is a schematic view of an image reading apparatus in a modified embodiment.

FIG. 16 is a block diagram showing a control system of an image forming apparatus in the modified embodiment.

### DESCRIPTION OF THE EMBODIMENTS

In the following, embodiments according to the present disclosure will be described using the attached drawings.

### First Embodiment

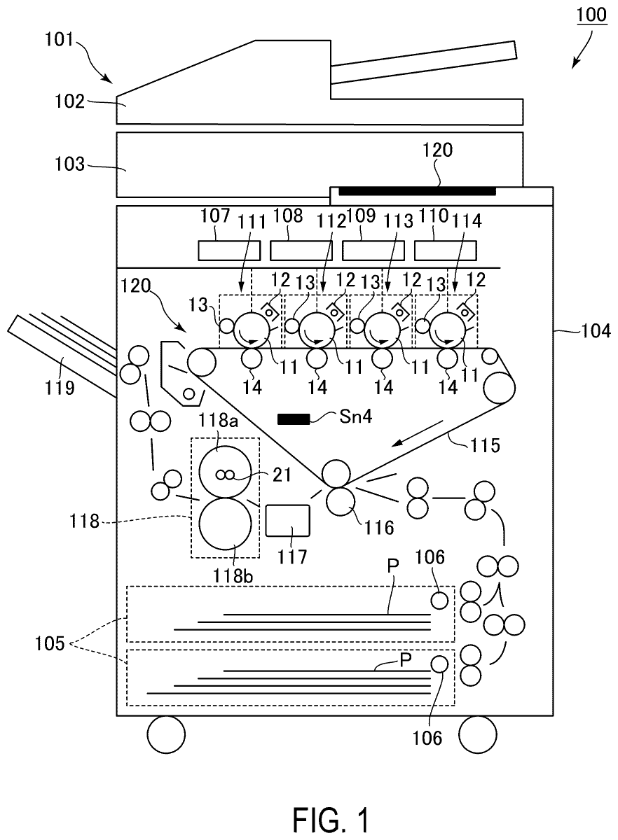

First, using FIG. 1, an image forming apparatus 100 according to a first embodiment will be described. The image forming apparatus 100 is an electrophotographic(-type) copying machine (or multi-function machine) provided with an image reading apparatus. This image forming apparatus 100 is merely an example of an image forming apparatus to which technology according to the present disclosure is applicable, and the “image forming apparatus” may also be, for example, a commercial large-speed printer or an apparatus of an ink jet type.

As shown in FIG. 1, the image forming apparatus 100 includes a printer main body 104 as an image forming apparatus main body, and an image reading apparatus 101 provided above the printer main body 104. The image forming apparatus 100 is capable of not only reading image information from an original by the image reading apparatus 101 but also forming an image on a recording material on the basis of the read image information. As a recording material (recording medium) and an original, it is possible to use various sheet materials different in size and material, including paper such as plain paper and thick paper; surface-treated sheet materials such as coated paper; special-shaped sheet materials such as an envelope and index paper; a plastic film; a cloth; and the like.

### (Printer Main Body)

Inside the printer main body 104, as an image forming unit for forming the image on the recording material P, an image forming portion 120 which is an electrophotographic engine is provided. The image forming portion 120 includes four process units 111, 112, 113, and 114 (image forming stations), and laser scanners 107, 108, 109, and 110 as exposure means. Further, the image forming portion 120 includes an intermediary transfer belt 115, a secondary transfer roller 116, and a fixing device 118.

Each of the process units 111 to 114 includes a photosensitive drum 11 as an image carrier, a charger (charging unit) 12, a developing unit 13, and a cleaning unit. The charger 12 is, for example, a charging roller contacting a surface of the photosensitive drum 11. The developing unit 13 includes a developing container for accommodating toner as a developer, and a developing roller (developer carrier) for supplying the toner to the photosensitive drum 11 while carrying the toner. The intermediary transfer belt 115 as an intermediary transfer member is stretched by a plurality of rollers. The four process units 111 to 114 are arranged and disposed along the intermediary transfer belt 115. On an inner peripheral surface side of the intermediary transfer belt 115, primary transfer rollers 14 are provided in positions opposing the associated photosensitive drums 11 while sandwiching the intermediary transfer belt 115. Further, as a nip between the secondary transfer roller 116 and the intermediary transfer belt 115, a transfer portion (secondary transfer portion) where transfer of a toner image is performed is formed.

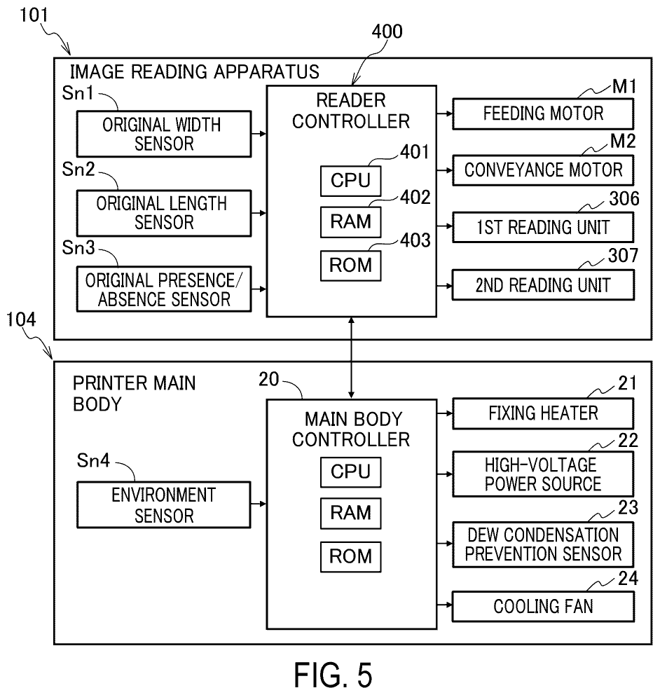

The fixing device 118 includes a fixing roller 118a, a pressing roller 118b (pressing member) press-contacted to the fixing roller 118a, and a fixing heater 21 (FIG. 5) for heating the fixing roller 118a. The fixing device 118 is a heat fixing-type unit for heating and pressing the image on the recording material P while nipping and conveying the recording material P in a fixing nip formed between the fixing roller 118a and the pressing roller 118b. The fixing device 118 is provided with a temperature detecting element such as a thermistor for detecting a temperature of the fixing roller 118a or the fixing heater 21. A main body controller 20 (FIG. 5) controls, on the basis of a detection result of the temperature detecting element, electric power supply to the fixing heater 21 during execution of an image forming operation so that the fixing roller 118a becomes a predetermined target temperature (fixing temperature) suitable for image fixing.

The fixing roller 118a is an example of a fixing member (heating member) and as the fixing roller 118a, a cylindrical film or an endless belt stretched by a plurality of rollers may also be used. The fixing heater 21 is a heat source for heating the fixing member (heating member). The fixing heater 21 may be, for example, a halogen lamp for emitting radiant heat, a heater substrate such that pattern of a heat penetrating resistor is printed on a ceramic substrate, or a coil unit in which an electroconductive layer in the heating member is caused to generate heat by a principle of induction heating.

An outline of the image forming operation which is a series of operations for forming the image on the recording material P by the image forming apparatus 100 will be described. A controller of the image forming apparatus 100 starts, for example, an image reading operation by the printer main body 104 and the image forming operation by the printer main body 104 in the case where a user pushes down a copy execution button in a state in which an original is set on the image reading apparatus 101. The controller controls the image forming apparatus 100 so as to form the image on the recording material P on the basis of image information acquired by causing the image reading apparatus 101 to execute the image reading operation. A constitution and the image detecting operation will be described later.

In the image forming operation, the photosensitive drums 11 of the process units 111 to 114 and the intermediary transfer belt 115 are rotationally driven. The charger 12 electrically charges a surface of the associated photosensitive drum 11 under application of a charging voltage from a charging voltage applying circuit of a high-voltage power source 22 (FIG. 5) mounted in the printer main body 104. The laser scanners 107 to 110 are driven on the basis of image data obtained by separating the image information into components of yellow, magenta, cyan, and black, and irradiates the photosensitive drums 11 with light. By this, the photosensitive drums 11 are exposed to light, so that electrostatic latent images are formed on surfaces of the photosensitive drums 11.

The developing unit develops the associated electrostatic latent image with toner as the developer. Specifically, by applying a developing voltage from a developing voltage applying circuit of the high-voltage power source 22 to the developing roller, so that the toner is transferred from the developing roller onto the associated photosensitive drum 11. By this, the electrostatic latent image is developed into a toner image. As a result, four single-color toner images of yellow, magenta, cyan, and black are formed on the four photosensitive drums 11, respectively.

These single-color toner images are primarily transferred onto the intermediary transfer belt 115 superposedly on each other by the primary transfer rollers 14 each to which a primary transfer voltage is applied from a primary transfer voltage applying circuit of the high-voltage power source 22. By this, a full-color toner image (hereinafter, simply referred to as a toner image) is formed on the intermediary transfer belt 115.

In parallel to formation of the toner image, the recording materials P are fed one by one from a feeding cassette 105 toward a secondary transfer portion by a feeding roller 106. A secondary transfer voltage is applied from a secondary transfer voltage applying circuit of the high-voltage power source 22 to the secondary transfer roller 116, whereby in the secondary transfer portion, the toner image is secondarily transferred from the intermediary transfer belt 115 onto the recording material P. The recording material P passing through the secondary transfer portion is sent to the fixing device 118, and the toner image is heated and pressed. By this, the toner image is fixed on the recording material S. The recording material P passes through the fixing device 118 is discharged to an outside of the printer main body 104 and is stacked on a discharge tray 119.

### (Image Reading Apparatus)

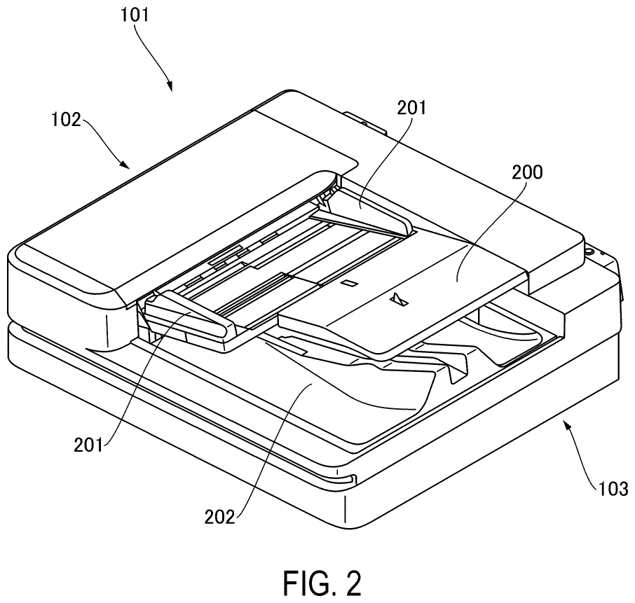

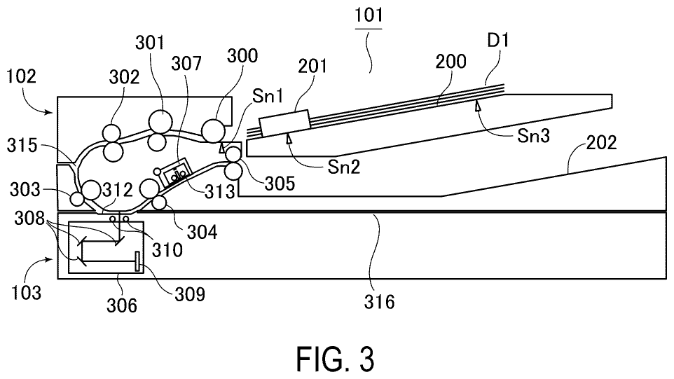

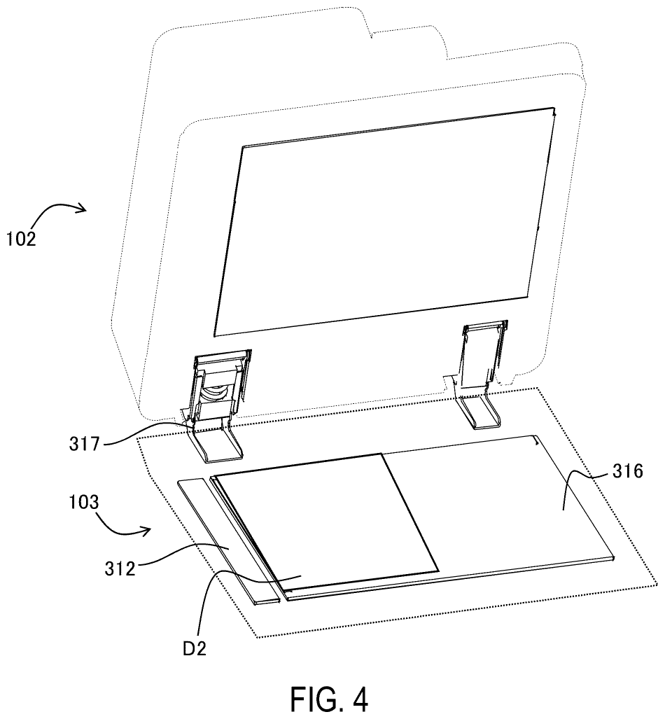

Next, the image reading apparatus 101 will be described principally using FIGS. 2 to 4. FIG. 2 is a perspective view of the image reading apparatus 101. FIG. 3 is a schematic view showing a cross section of the image reading apparatus 101. FIG. 4 is a schematic view showing the image reading apparatus 101 in a state in which an auto document (original) feeder (hereinafter, referred to as an ADF) 102 is open.

The image reading apparatus 101 includes a reader 103 and the ADF 102 (FIG. 1). The reader 103 is mounted on an upper portion of the printer main body 104. As shown in FIG. 4, the ADF 102 is supported by the reader 103 through a hinge 317 and is provided so as to be openable and closable relative to the reader 103. The ADF 102 is an example of a sheet feeding (conveying) apparatus for feeding (conveying) a sheet (original).

As shown in FIGS. 2 and 3, the reader 103 includes a first reading unit 306, a skim-through glass 312, and an original supporting platen glass 316. Further, the ADF 102 includes an original tray 200, a discharge tray 202, a second reading unit 307, and a skim-through glass 313. Further, the ADF 102 includes a pick-up roller 300, a separation roller pair 301, a drawing roller pair 302, a first lead roller pair 303, a second lead roller pair 304, and a discharging roller pair 305. Each of these conveying rollers (300 to 305) is an example of a conveying means for conveying an original D1.

The first reading unit 306 and the second reading unit 307 are examples of a reading means for reading the image information from an original to be conveyed. In this embodiment, the first reading unit 306 is an image sensor unit of a CCD type, and the second reading unit 307 is an image sensor unit of a CIS type. The first reading unit 306 includes a sensor substantially 309 on which light receiving elements are provided and arranged in a sheet width direction, a light source 310 for irradiating the original with light, and a plurality of mirrors 308 constituting a reduction optical system for forming an optical image of the original on a light receiving surface. The second reading unit 307 includes a CMOS sensor substrate on which light receiving elements are provided and arranged in the sheet width direction, a light source for irradiating the original with light, and a nonmagnification optical system for forming the optical image of the original on the light receiving surface.

Each of the first reading unit 306 and the second reading unit 307 as the reading means in this embodiment is a line sensor for acquiring a line image of the original in a predetermined reading (cyclic) period. The line image is an image for one row (line) on which pixels are arranged in the sheet width direction which is a main scan direction.

A reader controller 400 (FIG. 5) of the image reading apparatus 101 acquires image information as a two-dimensional image data by correcting the line images, acquired by the first reading unit 306 and the second reading unit 307, to each other in a sub-scan direction (original feeding direction).

The pick-up roller 300 is a pick-up member for feeding the original from the original tray 200 as a stacking portion where the original is stacked. The separation roller pair 301 includes a feed roller and a separating roller. The feed roller is a feeding member for feeding the original fed from the original tray 200. The separating roller is contacted to the feed roller and forms a separation nip therebetween.

The separating roller is an example of a separating member for separating the sheet by imparting a frictional force to the sheet. The separating roller may be a roller member supported through a torque limiter by a shaft member fixed to a frame of the ADF 102. Further, the separating roller may also be a retard drive-type roller to which a driving force in a direction (clockwise direction in FIG. 3) opposite to a movement direction (original feeding direction) of the original in the separation nip is inputted through a torque limiter. Further, instead of the separating roller, a pad-like elastic member (rubber pad) contacting the feed roller may also be used as the separating member.

The image reading apparatus 101 is capable of executing an image reading operation (skim-through operation) for reading image information of the original by the first reading unit 306 and the second reading unit 307 while feeding the originals one by one by the ADF 102. When the image reading operation is started, the pick-up roller 300 is rotated in a state in which the pick-up roller 300 contacts an uppermost original on the original tray 200, and thus feeds the original from the original tray 200. The separation roller pair 301 conveys the original by the feed roller while applying the frictional force to the original in the direction opposite to the original feeding direction in the separation nip by the separating roller. In the case where a plurality of originals enter the separation nip, the separating roller restrict that the original(s) other than a single original contacting the feed roller passes (path) through the separation nip. By this, the original passes through the separation nip in a singly separated state.

The original passed through the separation nip is successively conveyed in an order of the drawing roller pair 302, the first lead roller pair 303, and the second lead roller pair 304. In a process thereof, the first reading unit 306 optically scans a first surface (front surface) of the original through the skim-through glass 312 and converts image information into an electronic signal. The second reading unit 307 optically scans a second surface (back surface) of the original through the skim-through glass 313 and converts image information into an electronic signal. By this, image information as electronic image data is acquired. The original from which the image information is read is discharged from a conveying path in the ADF 102 by the discharging roller pair 305, and then is stacked on the discharge tray 202.

Incidentally, the image reading apparatus 101 is also capable of reading image information from a still original placed on the reader 103. In this case, the user opens the ADF 102 and sets an original D2 on the original supporting platen glass 316 of the reader 103, and then closes the ADF 102. Thereafter, the user provides an instruction to execute reading. Then, the first reading unit 306 optically scans the original D2 while moving in the sub-scan direction, and thus acquires image information.

### (Original Detecting Mechanism of ADF)

Further, the ADF 102 includes a detecting means for detecting a size of the original (i.e., size detecting means). The size detecting means in this embodiment is constituted by an original presence/absence sensor Sn1, an original width sensor Sn2, and an original length sensor Sn3. The original presence/absence sensor Sn1, the original width sensor Sn2, and the original length sensor Sn3 are examples of the size detecting means for acquiring information on the size of the original. Incidentally, the size detecting means may also be an operating panel through which the user is capable of inputting the size of the original.

Each of the original presence/absence sensor Sn1 and the original length sensor Sn3 is a sensor for detecting presence or absence of the original in a predetermined position on the original tray 200. The original presence/absence sensor Sn1 is disposed in the neighborhood of a position of an end portion on a side downstream of the original tray 200 with respect to the original feeding direction. The original length sensor Sn3 is disposed in a position spaced from the original presence/absence sensor Sn1 by a predetermined length on a side upstream of the original presence/absence sensor Sn1 with respect to the original feeding direction. As each of the original presence/absence sensor Sn1 and the original length sensor Sn3, it is possible to use optical sensors of a reflection type and a transmission type.

The original width sensor Sn2 is a sensor for detecting a width of the original in the original width direction perpendicular to the original feeding direction (original conveying direction). As the original width sensor Sn2, it is possible to use an optical sensor such as a photo-interrupter for detecting a position of side regulating plates 201 provided on the original tray 200. The side regulating plates 201 are a pair of regulating members which are movable in the original width direction in interrelation with each other and which are for regulating opposite side ends of the original with respect to the original width direction (FIG. 2).

Signals of these sensors (Sn1 to Sn3) are outputted to the reader controller 400 as shown in FIG. 5. FIG. 5 is a block diagram showing a control system of the image forming apparatus 100 according to this embodiment.

The reader controller 400 discriminates the presence or absence of the original on the original tray 200 on the basis of a detection result of the original presence/absence sensor Sn1. In addition, the reader controller 400 discriminates the length of the original on the original tray 200 in the original width direction (hereinafter, this length is simply referred to as an original width) on the basis of a detection result of the original width sensor Sn2. In addition, the reader controller 400 discriminates whether or not a length of the original on the original tray 200 with respect to the original feeding direction (hereinafter, this length is simply referred to as an original length) on the basis of a detection result of the original length sensor Sn3.

As shown in FIG. 5, both the pick-up roller 300 and the separation roller pair 301 are connected to a feeding motor M1 and are driven by the feeding motor M1. The drawing roller pair 302, the first lead roller pair 303, the second lead roller pair 304, and the discharging roller pair 305 are connected to a conveyance motor M2 and are driven by the conveyance motor M2. Each of the feeding motor M1 and the conveyance motor M2 is an example of a driving source for driving conveying means.

### (Control System of Image Forming Apparatus)

A control system of the image forming apparatus 100 will be described using FIG. 5. As shown in FIG. 5, the printer main body 104 includes the main body controller 20, and the image reading apparatus 101 includes the reader controller 400. The main body controller 20 and the reader controller 400 function as a control system for controlling an operation of the image forming apparatus 100 in cooperation with each other. The main body controller 20 not only controls an operation of the printer main body 104, but also administers an operation of entirety of the image forming apparatus 100 including the image reading apparatus 101. The reader controller 400 is a control means for controlling an operation of the image reading apparatus 101 on the basis of an instruction from the main body controller 20.

The reader controller 400 includes a CPU 401, a RAM 402, a ROM 403, and the like.

Further, to the reader controller 400, the original presence/absence sensor Sn1, the original width sensor Sn2, and the original length sensor Sn3 which are described above are connected, and the signals from the respective sensors are inputted. Further, the reader controller 400 is connected to the feeding motor M1 and the conveyance motor M2 which are the driving sources, and to the first reading unit 306 and the second reading unit 307 which are reading means, and controls these units. Further, to the reader controller 400, environment information detected by an environment sensor Sn4 of the printer main body 104 is inputted through the main body controller 20.

In the ROM 403, a program and data which are for controlling the image reading apparatus 101 are stored. The CPU 401 reads the program from the ROM 403 and executes the program while utilizing the RAM 402 as a working place (area). The CPU 401 controls operations of the driving sources (M1, M2) and the reading means (306, 307) on the basis of the detection results of the sensors (Sn1 to Sn4), so that the CPU 401 is capable of executing respective steps in each of flowcharts described later.

In this embodiment, the reader controller 400 sets driving speeds of the conveying rollers (300 to 305) by the feeding motor M1 and the conveyance motor M2 in conformity to a set value (aimed value, target value) of the original feeding speed. In addition, the reader controller 400 sets reading (cyclic) periods of the first reading unit 306 and the second reading unit 307 in conformity to the set value of the original feeding speed. The original feeding speed is not in advance depending on an execution condition such as a size of the original, resolution during reading, whether the reading is color reading or monochromatic reading, or whether the reading is double-side reading or one-side reading.

Further, in this embodiment, the reader controller 400 acquires the detection result, of the environment sensor Sn4 of the printer main body 104, as information showing an environment condition of the printer main body 104 (hereinafter, this information is referred to as environment information). In this embodiment, the “environment information (condition)” includes at least a condition of a temperature and a humidity. The reader controller 400 performs control of the motor driving speed and/or the reading period on the basis of the environment information acquired from the environment sensor Sn4 of the printer main body 104 as described specifically later.

As shown in FIG. 5, in the printer main body 104, the main body controller 20, the environment sensor Sn4, the fixing heater 21, the high-voltage power source 22, a dew condensation countermeasure heater 23, and a cooling fan 24 are provided. The main body controller 20 is connected to the environment sensor Sn4, and a signal from the environment sensor Sn4 is inputted to the main body controller 20. Further, the main body controller 20 controls operations of respective leads, of the printer main body 104, such as the fixing heater 21, the high-voltage power source 22, the dew condensation countermeasure heaters 23, the cooling fan 24, and the like. The fixing heater 21 and the high-voltage power source 22 are as described above, and therefore, will be omitted from description.

The main body controller 20 includes a CPU, a RAM, a ROM, and the like. In the ROM, a program and data which are for controlling the image forming apparatus 100 are stored. The CPU reads the program from the ROM and executes the program while utilizing the RAM as the working place. For example, the CPU of the main body controller 20 executes the above-described image forming operation by driving the conveying members of the image forming portion 120 and the printer main body 104 in accordance with the program.

The environment sensor Sn4 is a detecting means (environment detecting means) for detecting at least one of a temperature (ambient temperature) and a humidity (ambient humidity) in an environment in which the image forming apparatus 100 is installed. In the following, information of the ambient temperature detected by the environment sensor Sn4 is called temperature information, information of the ambient humidity detected by the environment sensor Sn4 is called humidity information, and the temperature information and the humidity information are collectively called environment information. The environment sensor Sn4 in this embodiment detects both the temperature information and the humidity information. Further, in this embodiment, relative humidity is used as an index of the humidity, but the index of the humidity acquired by using the environment sensor Sn4 may also be an absolute humidity.

Further, the environment sensor Sn4 may also be an apparatus inside sensor provided so as to detect a temperature/humidity inside a casing of the printer main body 104 or an apparatus outside sensor provided so as to detect a temperature/humidity outside the casing of the printer main body 104. As the environment sensor Sn4, both the apparatus inside sensor and the apparatus outside sensor may be used. The apparatus outside sensor is disposed, for example, in the neighborhood of a casing opening (inlet port) for taking in outside air from an outside of the casing by negative pressure generated by the cooling fan 24. On the other hand, the apparatus inside sensor is disposed in a position (particularly in the neighborhood of a component part liable to be influenced by a fluctuation in temperature and humidity) which is inside the casing and which is remote from the inlet port.

The dew condensation countermeasure heater 23 is a heater for warming the inside of the printer main body 104 for suppressing dew condensation in the printer main body 104. The dew condensation in the printer main body 104 is liable to generate in the case where a difference between a temperature ((apparatus) outside temperature) of the outside of the printer main body 104 and an apparatus inside temperature of the printer main body 104 is large. The case where the difference between the outside temperature and the apparatus inside temperature is large refers to, for example, the case where the respective component parts of the printer main body 104 greet morning in a state in which these parts are cool in the night, and then a room temperature is abruptly increased by a start of an operation of an air-conditioner in an office. When the dew condensation generates, depending on a generation position, an image defect and improper conveyance of the recording material P can occur. For example, when the dew condensation generates on a conveying guide for guiding the recording material P, the recording material P touches water droplet and thus is wetted when passes through the conveying guide, so that the wetted recording material P can cause the image defect is subsequent image formation and creases thereof. Further, the dew condensation occurs on the surface of the photosensitive drum 11, the dew condensation constitutes an obstacle to processes such as charging, light exposure, and the like in the electrophotographic process, and can cause the image defect.

The cooling fan 24 is a fan for cooling the inside of the printer main body 104. The cooling fan 24 takes in the outside air through the inlet port provided in the casing of the printer main body 104, and generates air flow for cooling the component parts in the printer main body 104. In a cooling object, the heat sources (for example, the fixing device 118 and the high-voltage power source 22) in the printer main body 104 and members (for example, the photosensitive drum 11 and the developing unit 13) having the influence on an image quality by the temperature increase are included.

### (Setting of Image Forming Condition Depending on Environment Information)

The main body controller 20 sets the image forming condition in the printer main body 104 on the basis of the environment information detected by the environment sensor Sn4. The image forming condition is a parameter or function setting, which are set for forming an appropriate image by the image forming operation.

In this embodiment, the image forming condition set on the basis of the environment information by the main body controller 20 at least includes a value of a fixing temperature, voltage values of various high voltages in the electrophotographic process, ON/OFF of the dew condensation countermeasure heater 23, and a driving state of the cooling fan 24. In other words, in this embodiment, a target temperature of the fixing device 118 is set on the basis of information detected by the environment sensor Sn4 (detecting means). Further, in this embodiment, at least one voltage value of the charging voltage, the developing voltage, and the transfer voltage is set on the basis of the information detected by the environment sensor Sn4 (detecting means). Further, in this embodiment, the driving state of the cooling fan 24 (fan) is set on the basis of the information detected by the environment sensor Sn4. Further, in this embodiment, execution or non-execution of heating by the dew condensation countermeasure heater 23 (heater) is set on the basis of the information detected by the environment sensor Sn4.

Incidentally, the image forming portion 120 in this embodiment is an electrophotographic mechanism of an intermediary transfer type, and therefore, the “transfer voltage” includes the primary transfer voltage and the secondary transfer voltage, and at least one of voltage values of these transfer voltages may only be required to be set on the basis of the environment information. In the case where an electrophotographic mechanism of a direct transfer type is used as the image forming portion 120, it may only be required that a voltage value of the transfer voltage applied to a transfer member (transfer unit) for transferring the image from the photosensitive drum 11 (image carrier) onto the recording material P is set on the basis of the environment information.

Specifically, the main body controller 20 in this embodiment changes a value of the fixing temperature so as to become higher with a lower environment temperature, on the basis of the environment information. This is because the temperature of the recording material P is low in the case where the environment temperature is low, and therefore, in order to obtain a good fixing property, there is a need to increase a heat quantity imparted to the recording material P by the fixing roller 118a when compared with the case where the environment temperature is high.

Further, the main body controller 20 changes various voltage values (for example, voltage values of the charging voltage, the developing voltage, the primary transfer voltage, and the secondary transfer voltage) in the electrophotographic process on the basis of the temperature information and the humidity information which are detected by the environment sensor Sn4. Depending on the environment temperature and the environment humidity, a charge retaining performance of the photosensitive drum 11 and a charging performance of the charging unit 12 is changed. For that reason, the main body controller 20 changes the charging voltage depending on the temperature information and the humidity information so that a surface potential of the photosensitive drum 11 after being charged by the charging unit 12 becomes a predetermined potential irrespective of the environment condition. Further, depending on the environment temperature and the environment humidity, the toner charging performance and a resistance value of the primary transfer portion changes. For that reason, in order that a good developing property and a good transfer property during the primary transfer can be obtained irrespective of the environment condition, the main body controller 20 changes the developing voltage and the primary transfer voltage depending on the temperature information and the humidity information. Further, in a low-temperature/low-humidity environment, the resistance value of the recording material P becomes high compared with a high-temperature/high-humidity environment. For that reason, in order that a good transfer property during the secondary transfer can be obtained irrespective of the environment condition, for example, in the low-temperature/low-humidity environment, the main body controller 20 increases the secondary transfer voltage (an absolute value thereof) compared with the high-temperature/high-humidity environment.

Further, on the basis of the temperature information detected by the environment sensor Sn4, the main body controller 20 causes the dew condensation countermeasure heater 23 to operate (ON) in the case where the difference between the apparatus outside temperature and the apparatus inside temperature is a threshold or more, and stops (OFF) the original of the dew condensation countermeasure heater 23 in the case where the temperature difference is less than the predetermined threshold. By this, in a state in which the temperature difference is large, which is a state in which the dew condensation is liable to generate, the inside of the printer main body 104 is warmed by the heat of the dew condensation countermeasure heater 23, so that it is possible to suppress that the dew condensation generates.

Further, on the basis of the temperature information (particularly, the apparatus inside temperature) detected by the environment sensor Sn4, the main body controller 20 controls drive of the cooling fan 24 so that the cooling fan 24 is operated in the case where the apparatus inside temperature is a predetermined temperature or more, or so that an member of air flow of the cooling fan 24 becomes larger with a higher apparatus inside temperature. In the case where the apparatus inside temperature is high, the inside of the printer main body 104 is cooled by the cooling fan 24, so that it is possible to suppress a deterioration in image quality due to a change in sensitivity of the photosensitive layer by the temperature rise of the photosensitive drum 11 and to suppress a deterioration of the toner due to the temperature rise of the developing unit 13.

Although the main body controller 20 in this embodiment sets the above-described conditions on the basis of the environment information, the main body controller 20 may also set an arbitrary one or more conditions of the above-described conditions on the basis of the environment condition.

For example, as an image forming condition set on the basis of the environment information acquired by the environment sensor Sn4, a constitution in which the main body controller 20 controls only the fixing temperature by the fixing heater 21 may be employed.

Further, the main body controller 20 may also be set an image forming condition other than the above-described image forming conditions, on the basis of the environment condition.

### (Adjustment Depending on Environment Condition in Image Reading Apparatus)

Mode control in which a set value of the original conveying speed is set depending on an original size and control in which a motor driving speed is corrected on the basis of the environment information will be described.

In the following description, the motor driving speed refers to rotational speeds of the feeding motor M1 and the conveying motor M2 when the ADF 102 conveys the original. Further, a speed in which the original receiving a conveying force from the conveying rollers (300 to 305) is moved along a conveying path 315 is referred to as a “conveying speed”. A relationship between the motor driving speed and the conveying speed is roughly as follows. An angular speed of each of the conveying rollers is determined by the motor driving speed and a (speed) reduction ratio of a drive transmitting mechanism for transmitting rotation from the motor to the associated conveying roller. A peripheral surface speed of the conveying roller is determined. In the case where the conveying roller does not slip with respect to the original, the peripheral surface speed of the conveying roller coincides with the conveying speed of the original. In actuality, a minute slip occurs between the conveying roller and the original in some cases, and therefore, the peripheral surface speed of the conveying roller does not always coincide with the conveying speed.

Incidentally, in the following, the driving speeds of the two motors (M1, M2) are collectively called the motor driving speed, but the rotational speeds of the two motors may be the same value and may also be values different from each other. That is, in the following description, the motor driving speed of the feeding motor M1 and the motor driving speed of the conveying motor M2 may be controlled independently of each other.

In this embodiment, the original tray 200 and the discharge tray 202 of the ADF 102 are disposed so as to overlap with each other as viewed in an up-down direction (vertical direction) (FIG. 3). For that reason, the conveying path 315 along which the original is conveyed from the original tray 200 toward the discharge tray 202 in a main body of the ADF 102 is curved in a substantially U-shape in a state in which the conveying path 315 is viewed in the original width direction perpendicular to the original conveyance direction. In other words, the original is fed from the original tray 200 toward one side (left side in FIG. 3) with respect to a horizontal direction, and is discharged on the discharge tray 202 toward the other side (right side in FIG. 3) with respect to the horizontal direction.

The original is conveyed in a curved state along the curved conveying path 315. For this reason, a conveyance resistance when the original is conveyed is different depending on a kind of the original. For example, depending on a size of the original, an area and a manner of contact of the original with the conveying path 315 are changed, and therefore the conveyance resistance is changed, so that the conveyance resistance becomes larger with a larger original size. On the other hand, at least a part of the conveying rollers (300 to 305) is constituted by a plurality of roller members (rollers) arranged in the original width direction, and therefore, the number of roller members simultaneously nipping the original is increased with an increasing original size, so that a conveying force applied to the original also becomes large.

Depending on the conveyance resistance received from the conveying path 315 by the original and the conveying force imparted to the original by the conveying rollers (300 to 305), a slip amount of the original relative to a conveying rollers fluctuates. For that reason, even when the feeding motor M1 and the conveying motor M2 are rotated at predetermined rotational speeds, depending on a condition such as the original size or the like, a conveying speed at which the original is actually conveyed is capable of fluctuating by about several %.

That is, even when the motor driving speeds are made constant, the action conveying speed of the original is capable of fluctuating by about several %.

Incidentally, each of the first reading unit 306 and the second reading unit 307 reads images (line images) of the original line by line on the basis of reception of a horizontal synchronizing signal is signal for instructing a line image acquiring timing to the reading means. An interval and a frequency of the horizontal synchronizing signal controller to a reading period and a reading frequency, respectively, at which the reader controller 400 provides an instruction to read the image to the reading means. On the basis of a set value (aimed value) of the conveying speed set in advance, the reading period is set so that an aspect ratio of a read image (a two-dimensional image obtained by arranging line images, acquired by the first reading unit 306 and the second reading unit 307, in the sub-scan direction) coincide with an actual aspect ratio of the original.

For that reason, when the conveying speed of the original fluctuates, a movement distance of the original during acquisition of line images for each (one) line by the first reading unit 306 and the second reading unit 307 is different as an interval between line images based on the set value of the conveying speed. For that reason, the read image becomes a state in which the read image is expanded or contracted in the sub-scan direction (original conveyance direction). Specifically, when an actual conveying speed is slower than the set value, the read image becomes long in the sub-scan direction. When the actual conveying speed is faster than the set value, the read image is contracted in the sub-scan direction on the basis of the original. Thus, when the conveying speed of the original is deviated from the set value due to the original size or the like, reading accuracy can lower.

For that reason, depending on the original size, the motor driving speed relative to the set value of the conveying speed of the original or the reading period of the reading unit (306, 307) is changed. That is, countermeasure such that depending on a basis weight of the original and/or a size condition of the original, a motor driving speed corresponding to a set value of a specific conveying speed is set to a different value is taken. In addition, countermeasure such that depending on the basis weight of the original and/or the size condition of the original, the reading period of the reading unit (306, 307) corresponding to the set value of the specific conveying speed is set to a different value is taken. By this, it is possible to suppress that the reading accuracy is lowered by a fluctuation in conveying speed of the original due to a difference in size.

However, even in the case where the above-described countermeasures are taken, the reading accuracy was lowered in some cases depending on a use environment of the image reading apparatus 101.

Specifically, rigidity and a surface property (friction coefficient with the conveying rollers) of the original change depending on a temperature/humidity condition. For example, in a low-humidity environment (about 10% RH), water content of the original is eliminated, so that the rigidity becomes large and the conveyance resistance becomes large, and a frictional force between the conveying rollers and the original becomes small. For that reason, in the low-humidity environment, a slip amount of each of the conveying rollers is increased compared with a comfortable humidity environment (about 50% RH to 60% RH) and the conveying speed of the original becomes slow, with the result that the read image is extended in the sub-scan direction in some cases. Further, in a high-humidity environment (about 80% RH), the rigidity becomes small and the conveyance resistance becomes small, and the frictional force between the conveying rollers and the original becomes large. For that reason, in the high-humidity environment, the slip amount of each of the conveying rollers is decreased compared with the comfortable humidity environment (about 50% RH to 60% RH) and the conveying speed of the original becomes fast, with the result that the read image is contracted in the sub-scan direction in some cases.

Thus, even when the countermeasure such that the motor driving speed or the reading period of the reading unit (306, 307) is changed depending on the basis weight or the size of the original, the reading accuracy was lowered depending on the environment condition in some cases.

In the above, as a factor such that the conveying speed is fluctuated depending on the environment condition, (1) the fluctuation in rigidity of the original due to the humidity, and (2) the fluctuation in frictional force between the original and the conveying rollers due to the humidity were cited, but as another factor, (3) a change in outer diameter of each of the conveying rollers has the influence on the conveying speed. In this embodiment, as each of the conveying rollers (300 to 305), a roller formed of a silicone rubber at an outer peripheral portion thereof is used. In this case, it is confirmed that the outer diameter of the conveying roller is fluctuated by about 0.10% to 0.15% when the ambient temperature fluctuates by 10° C. When the outer diameter of the conveying roller is fluctuated, even if an angular speed of the conveying roller is constant, a peripheral surface speed of the conveying roller changes, so that the fluctuation in conveying speed of the original occurs. That is, there is a tendency that the actual conveying speed of the original becomes fast with an increasing temperature of the image reading apparatus in the use environment.

The above-described factors (1) to (3) can occur even alone, but occur redundantly and thus a range of the fluctuation in conveying speed of the original is synergistically increased, so that an expansion/contraction amount of the reading accuracy is increased in some instances. As a result, depending on the environment condition, the reading accuracy is lowered in some cases.

### (Adjustment of Motor Driving Speed Depending on Environment Condition)

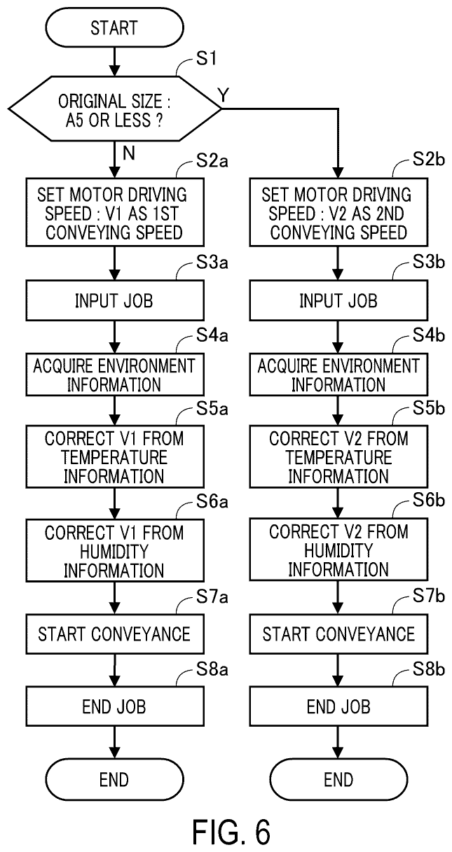

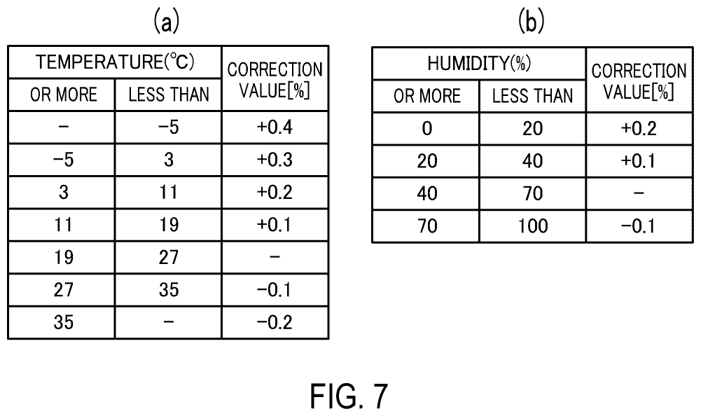

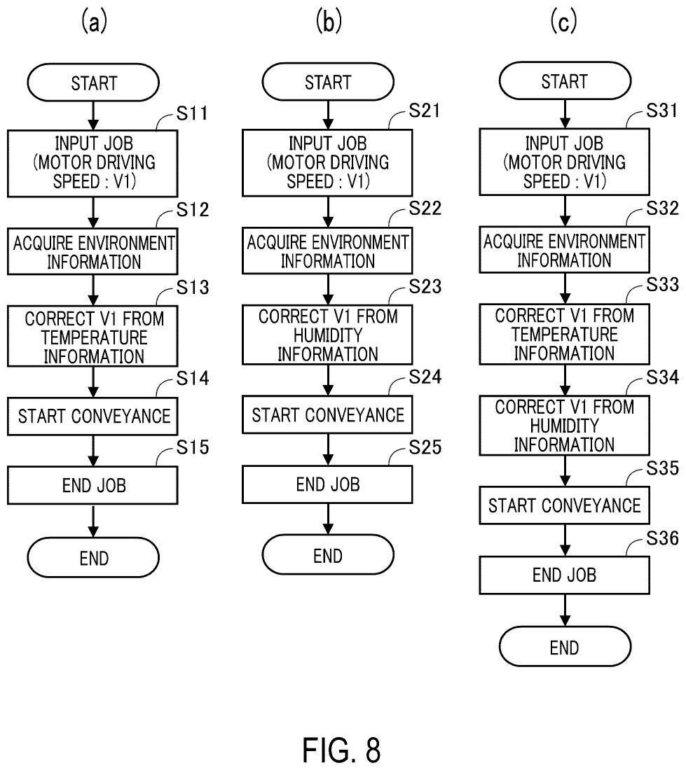

Therefore, in this embodiment, in order to enhance the accuracy of the embodiment image as can as possible irrespective of the environment condition, control such that the motor driving speed is corrected on the basis of the environment information detected by the environment sensor Sn4 of the printer main body 104 is performed. In the following, a control method of the image reading apparatus 101 in this embodiment will be described along a flowchart of FIG. 6.

The reader controller 400 first causes the original presence/absence sensor Sn1 to detect the presence or absence of the original on the original tray 200. When the reader controller 400 receives a detection signal of “presence” of the original from the original presence/absence sensor Sn1 by setting of the original by the user, the reader controller 400 discriminates a size of the original on the basis of a detection result of the original width sensor Sn2 and a detection result of the original length sensor Sn3 (S1).

In this embodiment, in the case where the original is a small size (for example, A5 (size) or less), an operation in s small-size mode (S3b to S8b) is executed, and in the case where the original is not the small size, an operation in a normal mode (S2a to S8a) is executed.

In the normal mode, the reader controller 400 sets a first conveying speed as a set value of the conveying speed (S2a). In the small-size mode, the reader controller 400 sets a second conveying speed, as a set value of the conveying speed, faster than the first conveying speed (S2b). Further, the reader controller 400 sets motor driving speeds V1 and V2 each corresponding to the conveying speed. The motor driving speed corresponding to the first conveying speed is V1, and the motor driving speed corresponding to the second conveying speed is V2.

The motor driving speed V1 and V2 are motor driving speeds in the case where correct-speeds V1 and V2 are set in advance so that the conveying speeds of the original coincide with the set values of the conveying speeds set in S2a and S2b, respectively under a standard environment condition. In the following control of the original in the normal mode and control of the original in the small size mode are basically the same except for difference of the motor driving speeds V1 and V2 and in correction value thereof, and therefore, will be collectively described.

When an execution instruction (JOB) of an image reading operation is inputted from the user (S3a, S3b), the reader controller 400 acquires pieces of environment information (temperature information and humidity information) which are detection results of the environment sensor Sn4 of the printer main body 104 (S4a, S4b).

Incidentally, the main body controller 20 updates values of the environment information on the basis of the detect results of the environment sensor Sn4, for example, during turning-on of a main power source of the image forming apparatus 100, during restoration from a sleep state, or at a time of an end of the image forming job, and then causes the RAM or the like to store the updated values. Further, the main body controller 20 sends the latest environment information values to the reader controller 400 in response to a request from the reader controller 400.

The reader controller 400 corrects the motor driving speeds V1 and V2 on the basis of the acquired temperature information (S5a, S5b). Specifically, values of the motor driving speeds V1 and V2 are increased or decreased by summing correction values based on a correction table of the motor driving speeds V1 and V2 set in S2a and S2b. Incidentally, the “correction value” is shown by a value represented by an amount to be added or subtracted in terms of % when a numerical value before correction is taken as 100%.

In this embodiment, a temperature of 19° C. to 27° C. is a standard temperature environment, and correction is made so that the motor driving speeds V1 and V2 are decreased in the case where the environment temperature is higher than this temperature range and so that the motor driving speeds V1 and V2 are increased in the case where the environment temperature is lower than this temperature range. That is, the motor driving speed in the case where the temperature detected by the detecting means (environment sensor Sn4) is a first temperature is a first speed, and the motor driving speed in the case where the temperature detected by the detecting means is a second temperature higher than the first temperature is a second speed. In this case, the reader controller 400 corrects the motor driving speed so that the second speed is slower than the first speed. The first temperature is, for example, 20° C. and the second temperature is, for example, 30° C. By this, it is possible to reduce the influence of a change in outer diameter of the conveying roller due to a level (high/low) of the temperature.

Further, the reader controller 400 corrects the motor speeds V1 and V2 on the basis of the acquired humidity information (S6a, S6b). Specifically, the reader controller 400 increases or decreases the motor driving speed by summing the motor driving speeds V1 and V2 after being corrected in S5a and S5b and correction values based on a correction table of part (b) of FIG. 7.

In this embodiment, a humidity of 40% to 70% is a standard humidity environment, and correction is made so that the motor driving speeds V1 and V2 are decreased in the case where the environment humidity is higher than this humidity range and so that the motor driving speeds V1 and V2 are increased in the case where the environment humidity is lower than this humidity range. That is, the motor driving speed in the case where the humidity detected by the detecting means (environment sensor Sn4) is a first humidity is a first speed, and the motor driving speed in the case where the humidity detected by the detecting means is a second humidity higher than the first humidity is a second speed. In this case, the reader controller 400 corrects the motor driving speed so that the second speed is slower than the first speed. The first humidity is, for example, 10% RH, and the second humidity is, for example, 50% RH. By this, it is possible to reduce the influence of a fluctuation in rigidity of the original and a fluctuation in friction force between the original and of the conveying roller due to a level (high/low) of the temperature.

Incidentally, the correction tables shown in parts (a) and (b) of FIG. 7 are stored in, for example, the ROM 403 of the reader controller 400, and the CPU makes reference to the correction tables by accessing the ROM 403. Further, as information other than the correction tables stored in the ROM 403, a coefficient of a function for representing the motor driving speeds V1 and V2 after the correction by using the motor driving speeds V1 and V2 before the correction and values of the temperature information as variable may also be stored in the ROM 403. In this case, the CPU 401 calculates the motor driving speeds V1 and V2 after the correction by using the coefficient of the function. Similarly, a coefficient of a function for representing the motor driving speeds V1 and V2 after the correction by using the motor driving speeds V1 and V2 before the correction and values of the humidity information as variables is stored in the ROM 403, and then, the CPU 401 may also calculate the motor driving speeds V1 and V2 after the correction by using the coefficient of the function. That is, irrespective of contents of specific processing in the reader controller 400, the reader controller 400 may only be required to be constituted so as to control the motor driving speed on the environment information consequently with the same contents as results of the corrections in this embodiment.

The reader controller 400 causes the motors (M1, M2) to be rotated at rotational speeds corresponding to the motor driving speeds V1 and V2 after the correction, respectively. By this, the conveying rollers (300 to 305) are rotationally driven at the motor driving speeds V1 and V2 after the correction. Further, the original is conveyed data conveying speed close to the first conveying speed or the second conveying speed, which is the set value (aimed value) of the conveying speed, and image information is read by the reading units (306, 307). As a result, expansion and contraction of the read member in the sub-scan direction due to a difference in environment condition can be suppressed, so that reading accuracy can be enhanced. When conveyance of all the originals stacked on the original tray 200 is ended, the reader controller 400 ends the image reading operation (S8a, S8b).

As described above, according to this embodiment, by utilizing the detection results of the environment sensor Sn4 of the printer main body 104, an image forming apparatus capable of improving image reading accuracy with a simple constitution is intended to be provided.

Further, according to the above-described flowchart, the reader controller 400 sets the set values of the conveying speeds of the original on the basis of the pieces of information acquired by the size acquiring means (Sn1 to Sn3). Further, the reader controller 400 corrects the motor driving speeds V1 and V2 set in advance corresponding to the set values of the conveying speeds, on the basis of the environment information detected by the detecting means (environment sensor Sn4), and then executes conveyance of the original on the basis of the motor driving speeds V1 and V2 after the correction. According to the flowchart in this embodiment, the reading accuracy can be improved even in the case where a fluctuation range of the conveying speed of the original due to the fluctuation in environment condition is different depending on the size of the original.

### Modified Embodiments

The correction table of part (a) of FIG. 7 is determined in advance on the basis of an evaluation result obtained by preliminarily evaluating a change amount, relative to the fluctuation in environment toner, of an outer diameter of each of the conveying rollers (300 to 305) used in this embodiment. Further, the correction table of part (b) of FIG. 7 is determined in advance on the basis of an evaluation result obtained by preliminarily evaluating a fluctuation in rigidity of a standard original due to the humidity and a fluctuation in frictional force between the original and the conveying roller due to the humidity. Accordingly, the correction values of parts (a) and (b) of FIG. 7 are merely examples and should be appropriately changed depending on specific constitutions of the conveying rollers.

Further, each of the correction tables of parts (a) and (b) of FIG. 7 may also be provided in a plurality of kinds thereof depending on a size and a material of the original. For example, the correction value in the operation in the normal mode may be different from the correction value in the operation in the small-size mode. As described above, the influence of the environment temperature and the environment humidity on the conveying speeds is capable of being changed depending on the size of the original and the material of the original. For that reason, different correction tables are selectively used depending on the size of the original or the material of the original, so that appropriate correction can be made for various materials of the originals.

Further, in this embodiment, a constitution in which the correction table based on the temperature condition and the correction table based on the humidity condition are individually prepared and in which correction values of these correction tables are added was employed, but a correction table based on a condition of a combination of the temperature and the humidity may be prepared. For example, it is also possible to set the correct value so that “the correct value of the motor driving speed is +0.4% in the case where both a temperature of 15° C. or less and a humidity of 10% or less are satisfied”.

Further, in this embodiment, the motor driving speed is corrected on the basis of three pieces of information consisting of the size of the original, and as the environment information, the temperature information and the humidity information, but these pieces of information may be used in various combinations. That is, depending on a specific constitution of the image reading apparatus 101, only a part of the above-described three pieces of information may also be used in consideration of a degree such that a factor capable of having the influence on the conveying speed of the original actually has the influence.

Each of parts (a) and (c) of FIG. 8 and parts (a) and (b) of FIG. 9 is a flowchart showing a modified embodiment in which a combination of the pieces of information used for determining the motor driving speed is different from the combination in another modified embodiment.

In the modified embodiment of part (a) of FIG. 8, the correction of the motor driving speed based on the temperature information is made without performing the setting of the conveying speed on the basis of the size of the original. In this modified embodiment, the reader controller 400 uses a conveying speed set in advance and the motor driving speed V1 corresponding thereto irrespective of the size of the original. When a job (JOB) is inputted (S11), the reader controller 400 acquires the environment information (temperature information) detected by the environment sensor Sn4 (S12), and corrects the motor driving surface V1 on the basis of the temperature information (S13). Then, the reader controller 400 causes the motors (M1, M2) at a rotation speed corresponding to the motor driving speed after the correction, so that conveyance of the original is started (S14). When conveyance of all the originals stacked on the original tray 200 is ended, the reader controller 400 ends the image reading operation (S15). According to this modified embodiment, a constitution capable of improving reading accuracy irrespective of the humidity condition can be realized by a simple control.

In the modified embodiment of part (b) of FIG. 8, the correction of the motor driving speed based on the humidity information is made without performing the setting of the conveying speed on the basis of the size of the original. In this modified embodiment, the reader controller 400 uses a conveying speed set in advance and the motor driving speed V1 corresponding thereto irrespective of the size of the original. When a job (JOB) is inputted (S21), the reader controller 400 acquires the environment information (humidity information) detected by the environment sensor Sn4 (S22), and corrects the motor driving surface V1 on the basis of the humidity information (S23). Then, the reader controller 400 causes the motors (M1, M2) at a rotation speed corresponding to the motor driving speed after the correction, so that conveyance of the original is started (S24). When conveyance of all the originals stacked on the original tray 200 is ended, the reader controller 400 ends the image reading operation (S25). According to this modified embodiment, a constitution capable of improving reading accuracy irrespective of the humidity condition can be realized by a simple control.

In the modified embodiment of part (c) of FIG. 8, the correction of the motor driving speed based on the temperature information and the humidity information is made without performing the setting of the conveying speed on the basis of the size of the original. In this modified embodiment, the reader controller 400 uses a conveying speed set in advance and the motor driving speed V1 corresponding thereto irrespective of the size of the original. When a job (JOB) is inputted (S31), the reader controller 400 acquires the environment information (temperature information and humidity information) detected by the environment sensor Sn4 (S32). The reader controller 400 corrects the motor driving surface V1 on the basis of the temperature information (S33) and corrects the motor driving speed V1 on the basis of the humidity information (S34). Then, the reader controller 400 causes the motors (M1, M2) at a rotation speed corresponding to the motor driving speed after the correction, so that conveyance of the original is started (S35). When conveyance of all the originals stacked on the original tray 200 is ended, the reader controller 400 ends the image reading operation (S36). According to this modified embodiment, a constitution capable of improving reading accuracy irrespective of the temperature condition and the humidity condition can be realized by a simple control.

In the modified embodiment of part (a) of FIG. 9, the setting of the conveying speed on the basis of the size of the original is performed, and in addition, the correction of the motor driving speed based on the temperature information is made. In this modified embodiment, the reader controller 400 discriminates the size of the original (S41) and sets the set value of the conveying speed of the original to the first conveying speed or the second conveying speed depending on a discrimination result (S42a, S42b) similarly as in the first embodiment. When a job (JOB) is inputted (S43a, S43b), the reader controller 400 acquires the environment information (temperature information) detected by the environment sensor Sn4 (S44a, S44b). The reader controller 400 corrects the motor driving surfaces V1 and V2 on the basis of the temperature information (S45a, S45b). Then, the reader controller 400 causes the motors (M1, M2) at a rotation speed corresponding to the motor driving speeds V1 and V2 after the correction, so that conveyance of the original is started (S46a, S46b). When conveyance of all the originals stacked on the original tray 200 is ended, the reader controller 400 ends the image reading operation (S47a, S47b). According to this modified embodiment, a constitution capable of improving reading accuracy irrespective of the size of the original and the temperature condition can be realized by a simple control.

In the modified embodiment of part (b) of FIG. 9, the setting of the conveying speed on the basis of the size of the original is performed, and in addition, the correction of the motor driving speed based on the humidity information is made. In this modified embodiment, the reader controller 400 discriminates the size of the original (S51) and sets the set value of the conveying speed of the original to the first conveying speed or the second conveying speed depending on a discrimination result (S52a, S52b) similarly as in the first embodiment. When a job (JOB) is inputted (S53a, S53b), the reader controller 400 acquires the environment information (humidity information) detected by the environment sensor Sn4 (S54a, S54b). The reader controller 400 corrects the motor driving surfaces V1 and V2 on the basis of the humidity information (S55a, S55b). Then, the reader controller 400 causes the motors (M1, M2) at a rotation speed corresponding to the motor driving speeds V1 and V2 after the correction, so that conveyance of the original is started (S56a, S56b). When conveyance of all the originals stacked on the original tray 200 is ended, the reader controller 400 ends the image reading operation (S57a, S57b). According to this modified embodiment, a constitution capable of improving reading accuracy irrespective of the size of the original and the humidity condition can be realized by a simple control.

### Second Embodiment

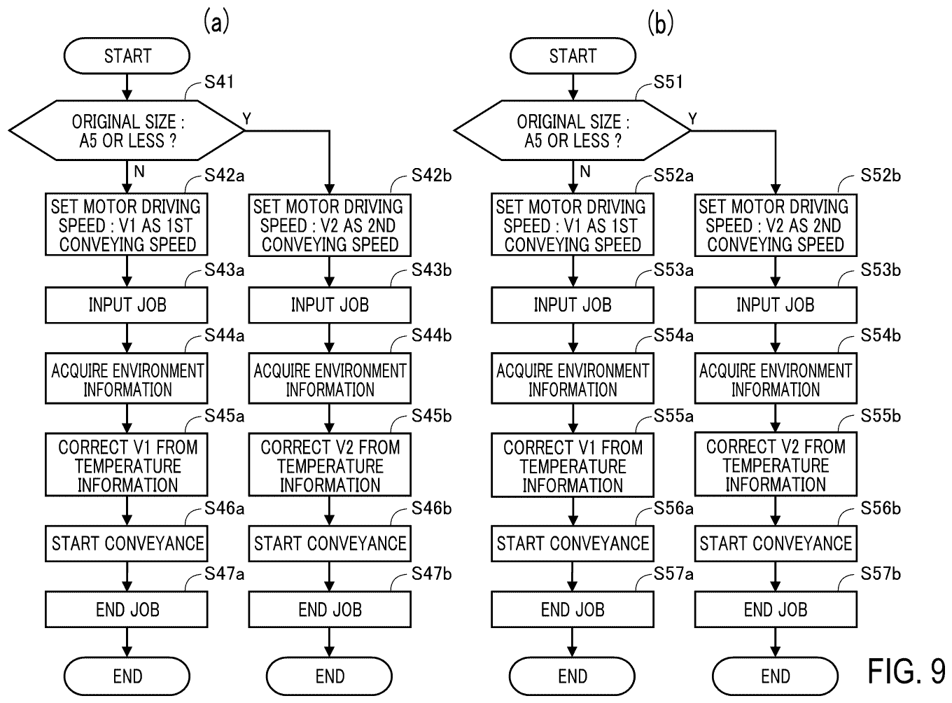

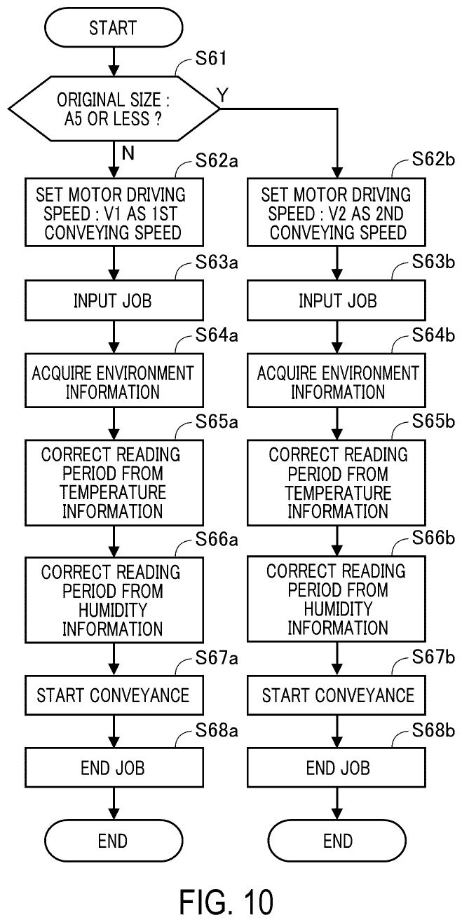

Next, a second embodiment in which the first embodiment is partially changed will be described using FIG. 10.

In the first embodiment, the correction of the motor driving speed based on the environment information was described, but in this embodiment, reading periods when the reading units (306, 307) read image information line by line are corrected on the basis of the environment information. In the following, elements represented by reference numerals or symbols common to the first embodiment and the second embodiment basically have the same constitutions and functions as those described in the first embodiment, and a portion different from the first embodiment will be principally described.

As shown in FIG. 10, in this embodiment, the controller 400 corrects the reading periods of the reading units (306, 307) on the basis of the temperature information and the humidity information. That is, the reader controller 400 corrects an interval in which a horizontal synchronizing signal instructing a line image acquiring timing to each of the first reading unit 306 and the second reading unit 307 on the basis of the temperature information and the humidity information.

In this embodiment, the reader controller 400 discriminates the size of the original (S61) and sets the set value of the conveying speed of the original to the first conveying speed or the second conveying speed depending on a discrimination result (S62a, S62b) similarly as in the first embodiment. When a job (JOB) is inputted (S63a, S63b), the reader controller 400 acquires the environment information (temperature information and humidity information) detected by the environment sensor Sn4 of the printer main body 104 (S64a, S64b). Then, the reader controller 400 corrects the motor driving speed on the basis of the temperature information (S65a, S65b) and further corrects the motor driving speed on the basis of the humidity information (S66a, S66b). Then, the reader controller 400 causes the motors (M1, M2) at rotational speeds corresponding to the motor driving speeds after the correction, so that conveyance of the original is started (S67a, S67b). When the conveyance of all the originals stacked on the original tray 200 is ended, the reader controller 400 ends the image reading operation (S68a, S68b).

In the case where the reading period is constant, as described above there is a possibility that an actual conveying speed of the original fluctuates depending on the environment condition and thus the read image is expanded and contracted in the sub-scan direction. According to this embodiment, even in the case where the conveying speed of the original fluctuates depending on the environment condition, the reading period is changed in conformity thereto. As a result, irrespective of a difference in environment condition, the reading units (306, 307) are caused to be capable of acquiring line images in an interval closer to a certain value with respect to the sub-scan direction. For example, in the case where the conveyance resistance is large and the actual conveying speed of the original becomes slower than the set value, the reading period is made longer than a reading period in a standard environment condition, so that it is possible to prevent that the read image is extended in the sub-scan direction.

Thus, according to this embodiment, by utilizing the detection result of the environment sensor Sn4 of the printer main body 104, an image forming apparatus capable of improving reading accuracy of the image with a simple constitution is intended to be provided.

In this embodiment, correcting values of the reading period based on the temperature information and the humidity information can be determined by the substantially same tables as the tables in the first embodiment in consideration that the correction tables shown in parts (a) and (b) of FIG. 7 show reading speeds (the number of line images acquired per unit time). However, in the case where a numerical value of the reading period (ON-interval of the horizontal synchronizing signal) is corrected, the reading period and the reading speed are in an inverse-proportional relationship, and therefore, values obtained by inverting signs of correction values [%] in parts (a) and (b) of FIG. 7 are used.

For example, in the case where the temperature information is 35° C. or more, on the basis of the temperature information, the reading period may only be required to be shortened by 0.2% (the reading speed may only be made faster than the reading speed in the standard environment by 0.2%). That is, the reading period in the case where the temperature detected by the detecting means (environment sensor Sn4) is a first temperature is a first reading period, and the reading period in the case where the temperature detected by the detecting means is a second temperature higher than the first temperature is a second reading period. In this case, the reader controller 400 corrects the reading period so that the second reading period is shorter than the first reading period. The first temperature is, for example, 20° C. and the second temperature is, for example, 38° C. By this, it is possible to reduce the influence of a change in outer diameter of the conveying roller due to a level (high/low) of the temperature.

Further, for example, in the case where the humidity information is 70% RH or more, on the basis of the humidity information, the reading period may only be required to be shortened by 0.2% (the reading speed may only be required to be made faster than the reading speed in the normal environment by 0.1%). That is, the reading period in the case where the humidity detected by the detecting means (environment sensor Sn4) is a first humidity is a first speed, and the motor driving speed in the case where the humidity detected by the detecting means is a second humidity higher than the first humidity is a second reading period. In this case, the reader controller 400 corrects the reading period so that the second reading period is shorter than the first reading period. The first humidity is, for example, 50% RH, and the second humidity is, for example, 80% RH. By this, it is possible to reduce the influence of a fluctuation in rigidity of the original and a fluctuation in friction force between the original and of the conveying roller due to a level (high/low) of the temperature.

### Modified Embodiment

In this embodiment, the case where the reading period of the first reading unit 306 and the reading period of the second reading unit 307 are corrected by the same correction value was described. The correction value is not limited thereto, and for the same reason as the reason in a third embodiment described below, the reading period of the first reading unit 306 and the reading period of the second reading unit 307 may also be corrected by correction values different from each other. That is, the reading periods of the two reading units 306 and 307 may have same difference therebetween so as to absorb a difference in conveying speed of the original between in a reading position of the first reading unit 306 and a reading position of the second reading unit 307. By this, the reading accuracy when the image is read from both surfaces (sides) of the original can be improved.

### Third Embodiment

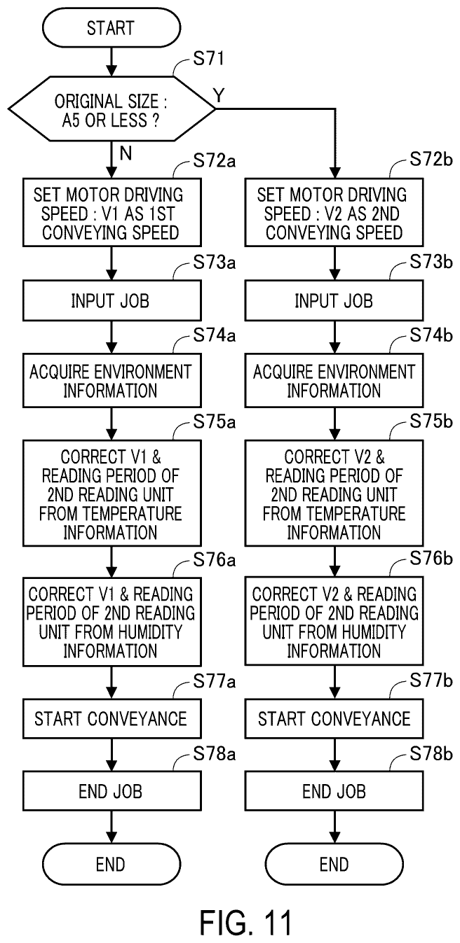

Next, a third embodiment in which the first embodiment and the second embodiment are combined with each other will be described using FIG. 11.

In this embodiment, both the correction of the motor driving speed described in the first embodiment and the correction of the reading period described in the second embodiment are made. In the following, elements represented by reference numerals or symbols common to the first to third embodiments basically have the same constitutions and functions as those described in the first and second embodiments, and a portion different from the first and second embodiments will be principally described.

In this embodiment, the reader controller 400 discriminates the size of the original (S71) and sets the set value of the conveying speed of the original to the first conveying speed or the second conveying speed depending on a discrimination result (S72a, S72b) similarly as in the first embodiment. When a job (JOB) is inputted (S73a, S73b), the reader controller 400 acquires the environment information (temperature information and humidity information) detected by the environment sensor Sn4 of the printer main body 104 (S74a, S74b). Then, the reader controller 400 corrects the motor driving speed on the basis of the temperature information, and in addition, corrects the reading period of the second reading unit 307 on the basis of the temperature information (S75a, S75b). Further, the reader controller 400 corrects the motor driving speed on the basis of the humidity information, and in addition, corrects the reading period of the second reading unit 307 on the basis of the humidity information (S76a, S76b). Then, the reader controller 400 causes the motors (M1, M2) at rotational speeds corresponding to the motor driving speeds after the correction, so that conveyance of the original is started (S77a, S77b). When the conveyance of all the originals stacked on the original tray 200 is ended, the reader controller 400 ends the image reading operation (S78a, S78b).

Here, in this embodiment, only for one (second reading unit 307) of the two reading units, along the above-described flowchart, in addition to the correction of the motor driving speed, the correction of the reading period is made. An advantage of this constitution will be described.

By making the correction of the motor driving speed on the basis of the temperature information and the humidity information, as described in the first embodiment, it is possible to reduce a fluctuation in conveying speed of the original due to the environment condition, so that it is possible to suppress expansion and contraction of the read image in the sub-scan direction. However, depending on a shape of the conveying path 315 or the like, there is a case where the conveying speed of the original is slightly different between the reading position (hereinafter, referred to as a first reading position) of the first reading unit 306 and the reading position (hereinafter, referred to as a second reading position) of the second reading unit 307.

For example, in the ADF 102 in this embodiment, the first reading unit 306 is immediately after a U-shaped curved portion of the conveying path 315, while the second reading unit 307 is disposed in a position remote from the curved portion. For that reason, a conveyance resistance received by the original in a periphery of the first reading unit 306 is liable to become larger than a conveyance resistance received by the original in a periphery of the second reading unit 307.

For that reason, even when the motor driving speed is corrected using the tables of parts (a) and (b) of FIG. 7 so that, for example, the conveying speed of the original in the first reading position coincides with the set value, the conveying speed of the original in the second reading position is slightly deviated from the set value in some instances. As a result, there is a possibility that slight expansion and contraction in the sub-scan direction occurs in the read image acquired by the second reading unit 307.

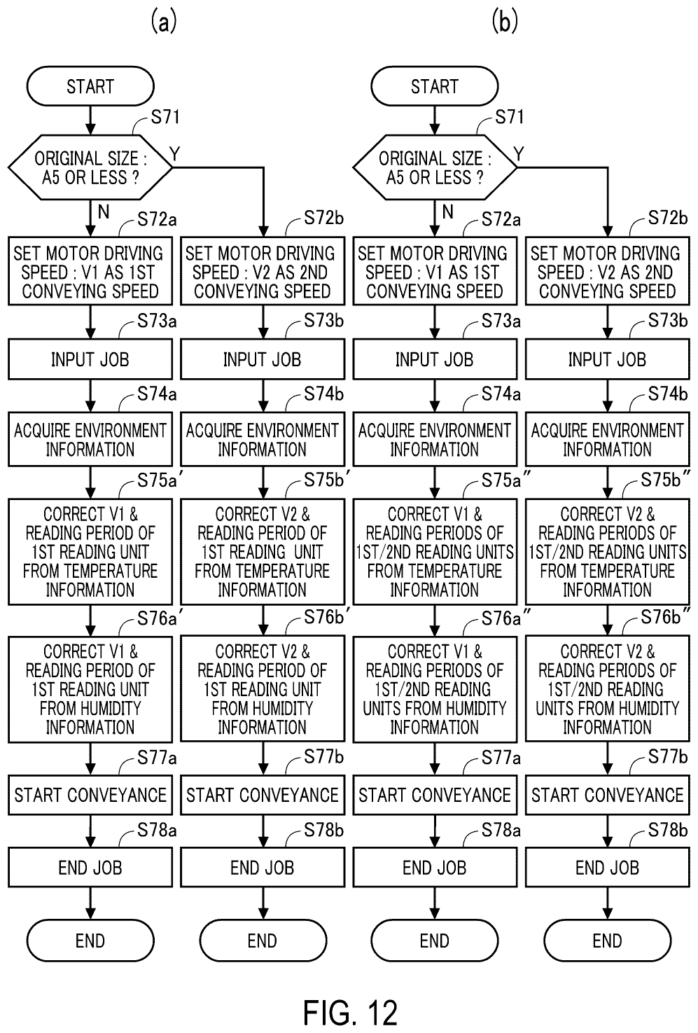

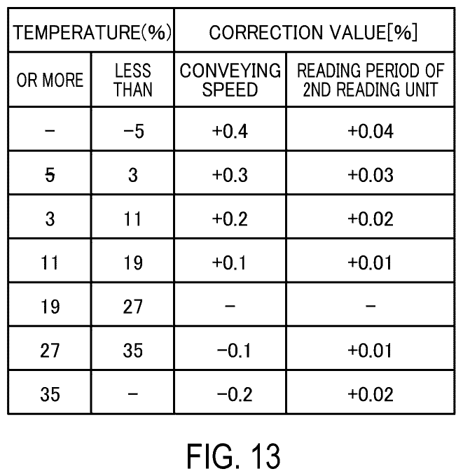

Therefore, in this embodiment, only for the second reading unit 307, in addition to the correction of the motor driving speed, the correction of the reading period is made, and thus absorbs a slight difference in conveying speed resulting from a difference in reading position. For example, in this embodiment, by using a correction table shown in FIG. 13, a correction value of the motor driving speed depending on the temperature information and a correction value of the reading period of the second reading unit 307 depending on the temperature information are determined. Further, in this embodiment, the reading period of the first reading unit 306 is constant.

In this embodiment, in either of the case where the motor driving speed is made fast by correction of the motor driving speed and the case where the motor driving speed is made show by the correction of the motor driving speed, there was a tendency that the conveying speed of the original in the second reading position becomes slightly slow compared with the conveying speed of the original in the first reading position. For that reason, in the correction table of FIG. 13, even in either one of the case where a value of the temperature information is higher than a standard temperature range (19° C. to 27° C.) and the case where the value of the recording material information is lower than the standard temperature range, a correction value for increasing the reading period (for slowing the reading speed) of the second reading unit 307 is set. However, the correction values in FIG. 13 are merely an example, and should be appropriately changed depending on a specific constitution of the ADF 102.

Thus, according to this embodiment, by utilizing the detection result of the environment sensor Sn4 of the printer main body 104, an image forming apparatus capable of improving reading accuracy of the image with a simple constitution is intended to be provided.

Further, according to this embodiment, only for one of the two reading units, the correction of the reading period is made in combination with the correction of the motor driving speed. In other words, the reader controller 400 changes either one of the reading period of the first reading unit and the reading period of the second reading unit so as to absorb the difference in feeding speed of the original between in the first reading position and in the second reading position in the case where the conveying rollers (300 to 305) are driven at a driving speed after being corrected by the reader controller 400 on the basis of the environment information detected by the environment sensor Sn4 (detecting means). By this, even in the case where the conveying speeds of the two reading units in the reading positions are delicately different from each other, the difference in conveying speed can be absorbed by the correction of the reading period. For this reason, the reading accuracy when the images are read from both surfaces of the original.

### Modified Embodiments

Incidentally, in the third embodiment, an example in which only for the second reading unit 307, the reading period is corrected on the basis of the environment information was described, but as shown in part (a) of FIG. 12, only for the first reading unit 306, the reading period may also be corrected on the basis of the environment information. In this modified embodiment, motor driving speeds are corrected using a correction table in which the conveying speed of the original in the second reading position preliminarily adjusted so as to coincide with the set value (S75a′, S75b′, S76a′, S76b′). Further, only for the first reading unit 306, correction of the reading period is made so as to absorb a difference in conveying speed of the original between in the first reading position and in the second reading position. By this, an advantage similar to the advantage of the third embodiment can be obtained.

Further, as shown in part (b) of FIG. 12, reading periods of both the first reading unit 306 and the second reading unit 307 may be corrected on the basis of the environment information (S75a″, S75b″, S76a″, S76b″). In this case, a correction value of the reading period of the first reading unit 306 and a correction value of the reading period of the second reading unit 307 are set to different values so as to absorb the difference in conveying speed of the original between in the first reading position and in the second reading position. In other words, the reading period of the first reading unit and the reading period of the second reading unit are made values different from each other so as to absorb the difference in conveying speed of the original between in the first reading speed and in the second reading speed in the case where the conveying rollers (300 to 305) are driven at the driving speed after being corrected by the reader controller 400 on the basis of the environment information detected by the environment sensor Sn4 (detecting means). By this, an advantage similar to the advantage of the third embodiment can be obtained.

### Fourth Embodiment

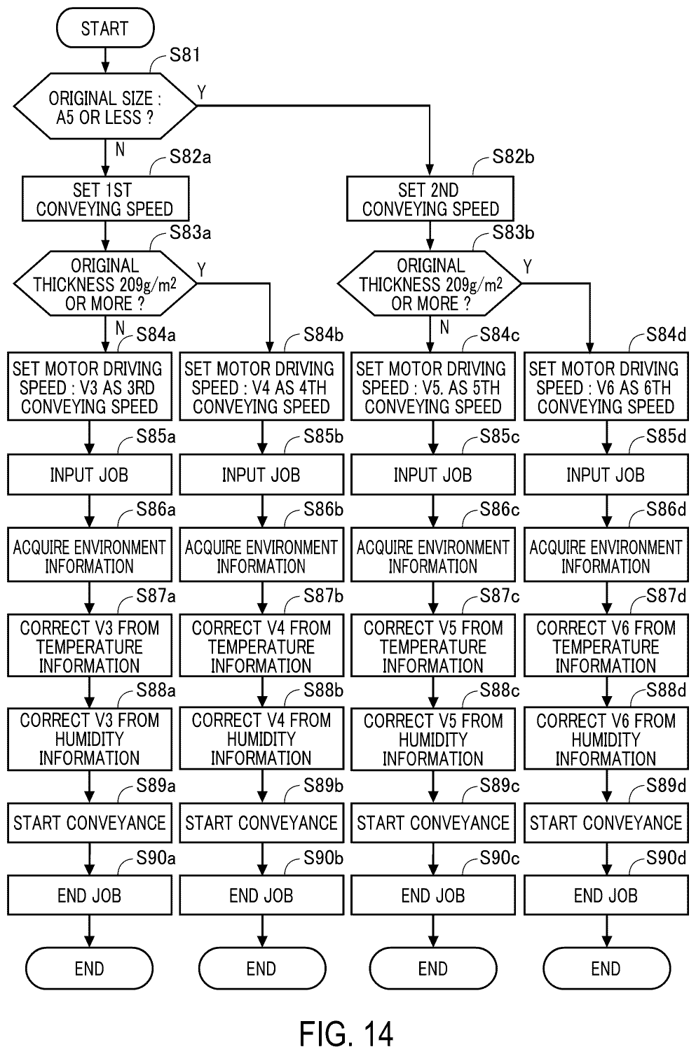

Next, a fourth embodiment will be described using FIGS. 14 to 16.

In this embodiment, the set value of the conveying speed is determined in consideration not only the size of the original but also a basis weight of the original, and in addition, the motor driving speed and the reading period are corrected on the basis of the environment information. In the following, elements represented by reference numerals or symbols common to the first to fourth embodiments basically have the same constitutions and functions as those described in the first to third embodiments, and a portion different from the first to third embodiments will be principally described.

The ADF102 in this embodiment is capable of conveying originals having various thicknesses from thin paper of 37 g/m² in basis weight to thick paper exceeding 209 g/m² in basis weight. On the other hand, the basis weight (thickness) is in a correlation with rigidity, and with a higher rigidity (a force for returning a shape of the original when the original is flexed) of the original, a conveyance resistance of the original when the original passes through the conveying path 315 becomes larger. For that reason, it is preferable that not only the set value of the conveying speed is changed depending on the size of the original, but also the set value of the conveying speed is changed depending on the basis weight.

FIG. 14 is a flowchart showing a control method of the image reading apparatus 101 in this embodiment. In this embodiment, the reader controller 400 discriminates the size of the original (S81) and sets the set value of the conveying speed of the original to the first conveying speed or the second conveying speed depending on a discrimination result (S82a, S82b) similarly as in the first embodiment. Further, the reader controller 400 discriminates the basis weight of the original (S83a, S83b), and depending on a discrimination result, sets the set value of the conveying speed of the original to either one of speeds from a third conveying speed to a sixth conveying speed (S84a to S84d). That is, in this embodiment, the set value of the conveying speed is determined on the basis of the size of the original and the basis weight (thickness) of the original.

The basis weight of the original is inputted by the user through an operating panel provided to the image forming apparatus 100. In this case, the operating panel functions as a thickness acquiring means for acquiring information on the thickness of the original. Further, in this embodiment, the mode is a thick paper mode in the case where the basis weight is 209 g/m² or more and is the normal mode in the case where the basis weight is less than 209 g/m². In an operation in the thickness paper mode, in order to stably convey a thick original, the set value of the conveying speed is suppressed to a value lower than a value in an operation in the normal mode. That is, the fourth conveying speed is slower than the third conveying speed, and the sixth conveying speed is slower than the fifth conveying speed. Further, the third conveying speed may be the same speed as the first conveying speed, and the fifth conveying speed may be the same speed as the second conveying speed.

When a job (JOB) is inputted (S85a to S85d), the reader controller 400 acquires the environment information (temperature information and humidity information) detected by the environment sensor Sn4 of the printer main body 104 (S86a to S86d). Then, the reader controller 400 corrects the motor driving speed on the basis of the temperature information (S87a to S87d) and further corrects the motor driving speed on the basis of the humidity information (S88a to S88d). Then, the reader controller 400 causes the motors (M1, M2) at rotational speeds corresponding to the motor driving speeds after the correction, so that conveyance of the original is started (S89a to S89d). When the conveyance of all the originals stacked on the original tray 200 is ended, the reader controller 400 ends the image reading operation (S90a to S90d).

Thus, according to this embodiment, by utilizing the detection result of the environment sensor Sn4 of the printer main body 104, an image forming apparatus capable of improving reading accuracy of the image with a simple constitution is intended to be provided.

Further, according to this embodiment, the set value of the conveying speed is changed depending on the thickness (basis weight) of the original. That is, according to the above-described flowchart, the reader controller 400 sets the set value of the conveying speed of the original on the basis of information acquired by the thickness acquiring means (operating panel). Further, the reader controller 400 corrects motor driving speeds V3 to V6 set in advance correspondingly to the set value of the conveying speed, on the basis of the environment information detected by the detecting means (environment sensor Sn4), and then executes conveyance of the original on the basis of the motor driving speed after the correction. According to the above-described flowchart, even in the case where a fluctuation range of the conveying speed of the original due to the fluctuation in environment condition is different depending on the thickness of the original, the image reading accuracy can be improved. That is, for the originals formed of various materials, the motor driving speed can be appropriately corrected, so that the image reading accuracy can be further improved.

### Modified Embodiments

In this embodiment, a threshold for discriminating the mode as the thick paper mode was set to 209 g/m², but the threshold may be changed depending on a specific constitution of the ADF 102. Further, depending on the basis weight, the set value of the conveying speed may be changed between three stages (levels) or more.

Further, in this embodiment, a constitution in which the set value of the conveying speed is determined in consideration of both the size of the original and the thickness (basis weight) of the original was described as an example, but the set value of the conveying speed may also be determined in consideration of only the thickness (basis weight) of the original.

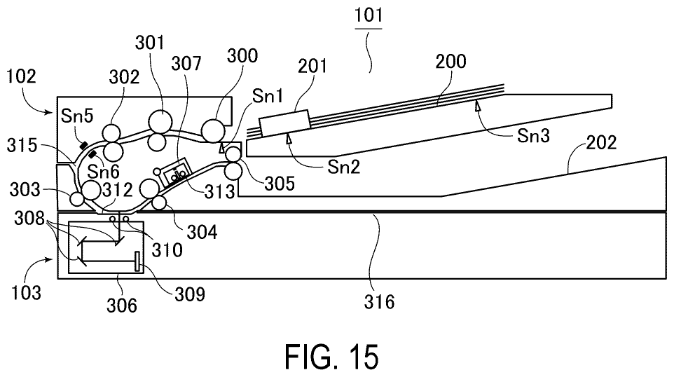

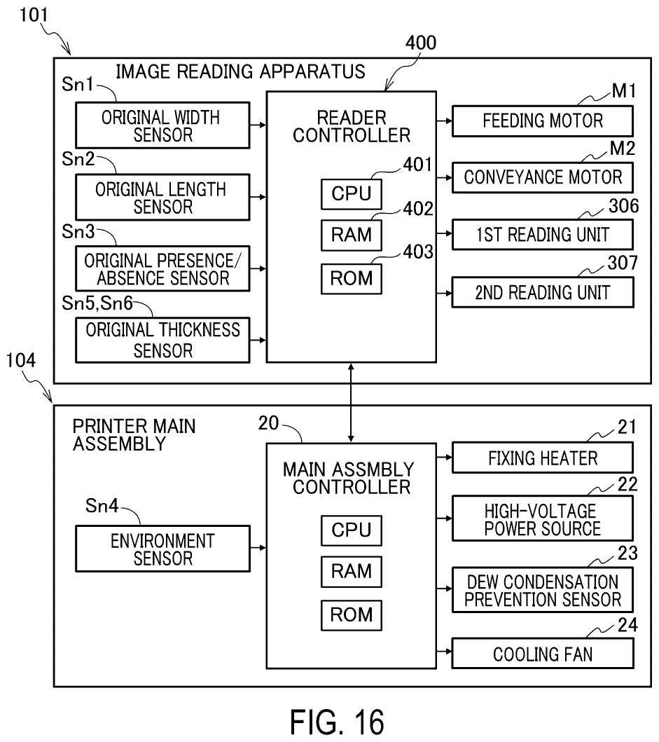

Further, instead of a method in which the user inputs the basis weight through the operating panel, as shown in FIGS. 15 and 16, original thickness sensors Sn5 and Sn6 for detecting the thickness of the original may be provided in the ADF 102. The original thickness sensors Sn5 and Sn6 are another example of the thickness acquiring means. Each of the original thickness sensors Sn5 and Sn6 is, for example, an ultrasonic sensor which includes a transmitter for emitting ultrasonic wave toward the conveying path and a receiver for receiving the ultrasonic wave passing through the original and which is for detecting the thickness of the original on the basis an attenuation factor of the ultrasonic wave. In this case, the reader controller 400 is capable of automatically discriminating the thickness of the original on the basis of detection results of the original thickness sensors Sn5 and Sn6 after a start of the conveyance of the original. Further, In this case, the reader controller 400 starts the conveyance of the original at the first conveying speed or the second conveying speed and discriminates the thickness of the original, and thereafter, the reader controller 400 may perform correction of the motor driving speed.

### Other Modified Embodiments

Technical elements described above in the embodiments and the modified embodiments can be applied to a single apparatus by being arbitrarily combined with each other unless these factors essentially contradict with each other. For example, the set value of the conveying speed is determined depending on the thickness of the original as in the fourth embodiment, and in addition, the reading period may be corrected on the basis of the environment information as in the second embodiment. Further, in combination with the corrections (S87a to S87d, S88a to S88d) of the motor driving speeds on the basis of the environment information in the fourth embodiment, the reading period of only the second reading unit 307 may be corrected as in the third embodiment.

Further, in the above-described embodiments, examples in which the reader controller 400 mounted to the image reading apparatus 101 corrects the motor driving speed and/or the reading period on the basis of the environment information detected by the environment sensor Sn4 were described. The present disclosure is not limited thereto, and for example, the main body controller 20 mounted to the printer main body 104 calculates a correction value of the motor driving speed and/or the reading period on the basis of the environment information detected by the environment sensor Sn4, and then transmits the calculated correction value to the reader controller 400. In this case, the reader controller 400 for correcting the motor driving speed and/or the reading period on the basis of the correction value received from the main body controller 20 is also an example of the correcting means.

### Another Embodiment

The present disclosure is also capable of being realized by processing in which a program for realizing one or more functions of the above-described embodiments is supplied to a system or an apparatus through a network or a storage medium and then one or more processors in a computer of the system or the apparatus read out and execute the program. Further, the present disclosure is also capable of being realized by a circuit (for example, application specific integrated circuit (ASIC) for realizing one or more functions.

According to the present disclosure, it is possible to provide the image forming apparatus capable of improving the image reading accuracy with the simple constitution.

### OTHER EMBODIMENTS

The above-described embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., the ASIC) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instruction. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-094314, filed on Jun. 11, 2024, which is hereby incorporated by reference herein in its entirety.

What is claimed is:

1. An image forming apparatus comprising:
an apparatus main body including an image forming unit for forming an image on a recording material and an environment sensor for acquiring environment information including at least one of a temperature and a humidity, the apparatus main body being configured to set an image forming condition on the basis of the environment information acquired by the environment sensor; and
an image reading apparatus including a conveying roller for conveying an original, a motor for driving the conveying roller, a reading sensor for reading image information from the original conveyed by the conveying roller, and a controller for controlling the motor, the image reading apparatus being provided on the apparatus main body,
wherein the controller controls a driving speed of the conveying roller driven by the motor, on the basis of the environment information acquired by the environment sensor of the apparatus main body.

2. An image forming apparatus according to claim 1, wherein the environment sensor detects the humidity in an environment, and
wherein the controller controls the driving speed on the basis of the environment information on the humidity.

3. An image forming apparatus according to claim 2, wherein the controller controls the driving speed so as to be a first speed when the humidity detected by the environment sensor is a first humidity and a second speed slower than the first speed when the humidity detected by the environment sensor is a second humidity higher than the first humidity.

4. An image forming apparatus according to claim 1, wherein the environment sensor detects the temperature in an environment, and
wherein the controller controls the driving speed on the basis of the environment information on the temperature.

5. An image forming apparatus according to claim 4, wherein the controller controls the driving speed so as to be a first speed when the temperature detected by the environment sensor is a first temperature and a second speed slower than the first speed when the temperature detected by the environment sensor is a second temperature higher than the first temperature.

6. An image forming apparatus according to claim 1, wherein the image reading apparatus includes a size acquiring unit for acquiring information on a size of the original, and
wherein the controller determines the driving speed on the basis of both the information on the size of the original acquired by the size acquiring unit and the environment information acquired by the environment sensor.

7. An image forming apparatus according to claim 1, wherein the reading sensor is a first reading sensor for reading image information line by line from a first surface of the original in a first reading position,
wherein the image reading apparatus includes a second reading sensor for reading image information line by line from a second surface of the original in a second reading position different from the first reading position with respect to an original conveyance direction, and
wherein the controller sets a reading period of the first reading sensor and a reading period of the second reading sensor to values different from each other.

8. An image forming apparatus according to claim 1, wherein the image forming unit includes a fixing device in which the image formed on the recording material is heated and fixed on the recording material, and
wherein a target temperature of the fixing device is set on the basis of the environment information acquired by the environment sensor.

9. An image forming apparatus according to claim 1, wherein the image forming unit includes an image carrier, a charger for electrically charging a surface of the image carrier under application of a charging voltage, a developer carrier for supplying toner to the image carrier under application of a developing voltage, and a transfer member for transferring the image from the image carrier onto the recording material under application of a transfer voltage, and
wherein a voltage value of at least one of the charging voltage, the developing voltage, and the transfer voltage is set on the basis of the environment information acquired by the environment sensor.

10. An image forming apparatus according to claim 1, wherein the apparatus main body further includes a fan for cooling an inside thereof, and
wherein a driving state of the fan is set on the basis of the environment information acquired by the environment sensor.

11. An image forming apparatus according to claim 1, wherein the apparatus main body includes a heater for heating at least a part of the apparatus main body in order to suppress dew concentration in the apparatus main body, and
wherein execution or non-execution of heating by the heater is set on the basis of the environment information acquired by the environment sensor.

12. An image forming apparatus comprising:
an apparatus main body including an image forming unit for forming an image on a recording material and an environment sensor for acquiring environment information including at least one of a temperature and a humidity, the apparatus main body being configured to set an image forming condition on the basis of the environment information acquired by the environment sensor; and
an image reading apparatus including a conveying roller for conveying an original, a reading sensor for reading image information line by line from the original conveyed by the conveying roller, and a controller for controlling the reading sensor, the image reading apparatus being provided on the apparatus main body,
wherein the controller controls a reading period when the reading sensor reads the image information, on the basis of the environment information acquired by the environment sensor of the apparatus main body.

13. An image forming apparatus according to claim 12, wherein the environment sensor detects the humidity in an environment, and
wherein the controller controls the reading period on the basis of the environment information on the humidity.

14. An image forming apparatus according to claim 13, wherein the controller controls the reading period of the reading sensor so as to be a first period when the humidity detected by the environment sensor is a first humidity and a second period shorter than the first period when the humidity detected by the environment sensor is a second humidity higher than the first humidity.

15. An image forming apparatus according to claim 13, wherein the environment sensor detects the temperature in an environment, and
wherein the controller controls the reading period on the basis of the environment information on the temperature.

16. An image forming apparatus according to claim 15, wherein the controller controls the reading period of the reading sensor so as to be a first period when the temperature detected by the environment sensor is a first temperature and a second period shorter than the first period when the temperature detected by the environment sensor is a second temperature higher than the first temperature.

17. An image forming apparatus according to claim 12, wherein the image forming unit includes a fixing device in which the image formed on the recording material is heated and fixed on the recording material, and
wherein a target temperature of the fixing device is set on the basis of the environment information acquired by the environment sensor.

18. An image forming apparatus according to claim 12, wherein the image forming unit includes an image carrier, a charger for electrically charging a surface of the image carrier under application of a charging voltage, a developer carrier for supplying toner to the image carrier under application of a developing voltage, and a transfer member for transferring the image from the image carrier onto the recording material under application of a transfer voltage, and
wherein a voltage value of at least one of the charging voltage, the developing voltage, and the transfer voltage is set on the basis of the environment information acquired by the environment sensor.

19. An image forming apparatus according to claim 12, wherein the apparatus main body further includes a fan for cooling an inside thereof, and
wherein a driving state of the fan is set on the basis of the environment information acquired by the environment sensor.

20. An image forming apparatus according to claim 12, wherein the apparatus main body includes a heater for heating at least a part of the apparatus main body in order to suppress dew concentration in the apparatus main body, and
wherein execution or non-execution of heating by the heater is set on the basis of the environment information acquired by the environment sensor.
